(19) United States
(12) Patent Application Publication
(10) Pub. No.: US 2018/0239441 A1
(43) Pub. Date: Aug. 23, 2018

(54) OPERATION SYSTEM

(71) Applicant: DENSO CORPORATION, Kariya-city, Aichi-pref. (JP)

(72) Inventors: Takuya OSUGI, Kariya-city (JP); Hideki ITO, Kariya-city (JP); Tetsuya TOMARU, Kariya-city (JP); Yoshiyuki TSUDA, Kariya-city (JP); Shigeaki NISHIHASHI, Kariya-city (JP); Hiroyuki KOGURE, Kariya-city (JP)

(21) Appl. No.: 15/554,811

(22) PCT Filed: Mar. 4, 2016
(86) PCT No.: PCT/JP2016/001196

§ 371 Date: Aug. 31, 2017

(30) Foreign Application Priority Data
Mar. 25, 2015 (JP) 2015-063293

(51) Int. Cl. G06F 3/038; B60K 37/06

(52) U.S. Cl. CPC G06F 3/038; B60K 37/06; B60K 2350/2052; B60K 2350/1024; G06F 2203/0381

(57) ABSTRACT

An operation system includes: an operation device manually operated by a user; a control device that controls actions of a plurality of apparatuses according to a visual line direction of the user detected by a visual line detection sensor and an operation content of the operation device; and a contact detection device that detects that the user touches the operation device. The control device enables the visual line direction detected by the visual line detection sensor and reflects the visual line direction in a control of the control device when the contact detection device detects that the user touches the operation device.

### CROSS REFERENCE TO RELATED APPLICATION

This application is based on Japanese Patent Application No. 2015-63293 filed on Mar. 25, 2015, the disclosure of which is incorporated herein by reference.

### TECHNICAL FIELD

The present disclosure relates to an operation system in which an operation device and sight line detection are cooperated with each other.

### BACKGROUND ART

In recent years, a sight line detection sensor which detects a sight line of a user is under development (refer to Patent Literatures 1 and 2). In the sight line detection sensor, when it is desired to cause an apparatus to act with desired contents, a command for the contents can be given to the apparatus merely by moving the sight line.

For example, an operation system described in Patent Literature 1 is provided with an operation key which adjusts angles of a rearview mirror (apparatus) and a sideview mirror (apparatus) of a vehicle, a sight line detection sensor, and a trigger switch. Sight line detection by the sight line detection sensor is enabled when a user turns on the trigger switch. Accordingly, an apparatus that is located within the detected sight line direction can be controlled by the operation key.

However, the operation system described in Patent Literature 1 requires turning on the trigger switch in addition to moving the slight line to operate the operation key, which is troublesome.

### PRIOR ART LITERATURES

### Patent Literature

Patent Literature 1: JP-5588764-B1

Patent Literature 2: JP-2014-174598-A

### SUMMARY OF INVENTION

It is an object of the present disclosure to provide an operation system in which an operation device and sight line detection are cooperated with each other and which has an improved operability.

According to an aspect of the present disclosure, an operation system includes: an operation device manually operated by a user; a control device that controls actions of a plurality of apparatuses according to a visual line direction of the user detected by a visual line detection sensor and an operation content of the operation device; and a contact detection device that detects that the user touches the operation device. The control device enables the visual line direction detected by the visual line detection sensor and reflects the visual line direction in a control of the control device when the contact detection device detects that the user touches the operation device.

When a user has an intention of giving a command to an apparatus, the user should touch the operation device. According to the operation system focusing on this point, the visual line detection is enabled merely by the touch of a user on the operation device, and the visual line direction can be reflected in control. Thus, it is possible to eliminate the necessity of the operation of the trigger switch according to Patent Literature 1 and to improve the operability. Further, it is possible to avoid troublesomeness caused by the reflection of the visual line direction detected by the visual line detection sensor in control when a user is not in contact with the operation device, that is, a user has no intention of giving a command to an apparatus.

### BRIEF DESCRIPTION OF DRAWINGS

The above and other objects, features and advantages of the present disclosure will become more apparent from the following detailed description made with reference to the accompanying drawings. In the drawings:

FIG. 1 is a perspective view illustrating vehicle-mounted positions of an operation device and a sight line detection sensor in a first embodiment of the present disclosure;

FIG. 2 is a diagram illustrating a relationship between display contents of display devices illustrated in FIG. 1 and a sight line direction of a user;

FIG. 3 is a control block diagram illustrating the operation device, a proximity sensor, the sight line detection sensor, and the display devices illustrated in FIG. 1;

FIG. 4 is a flowchart illustrating a procedure of control performed by a microcomputer of FIG. 3;

FIG. 5 is a control block diagram according to a second embodiment of the present disclosure; and

FIG. 6 is a perspective view illustrating vehicle-mounted positions of an operation device and a sight line detection sensor in a third embodiment of the present disclosure.

### EMBODIMENTS FOR CARRYING OUT INVENTION

### First Embodiment

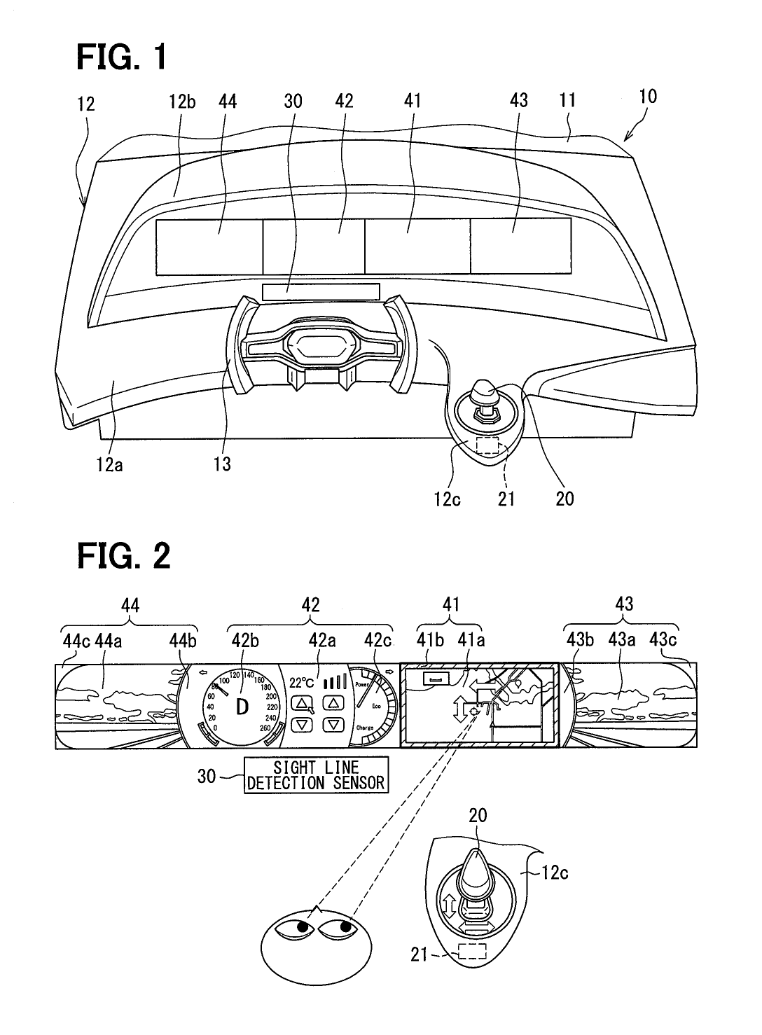

FIG. 1 is a perspective view of a vehicle front side viewed from the inside of a cabin of a vehicle 10. As illustrated, an instrument panel 12 which is made of a resin is installed under a front windshield 11 inside the vehicle cabin. The instrument panel 12 includes a horizontal portion 12a which expands in the horizontal direction, a projecting portion 12b which projects upward from the horizontal portion 12a, and an extending portion 12c which extends toward the rear side of the vehicle from the horizontal portion 12a. The projecting portion 12b has a shape including an opening which is open toward the rear side of the vehicle. A plurality of (four in an example of FIG. 1) display devices 41, 42, 43, 44 are disposed on the opening. The display devices 41, 42, 43, 44 are arranged in a row in a right-left direction of the vehicle 10 (a right-left direction of FIG. 1).

Each of the display devices 41, 42, 43, 44 is provided with a liquid crystal panel and a backlight. The display devices 41, 42, 43, 44 have the same shape and the same size. The display devices 41, 42, 43, 44 are adjacently arranged so that display surfaces of the liquid crystal panels are visually recognized as being continuous in the right-left direction of the vehicle, that is, visually recognized as one display surface extending in the right-left direction. In front view of the instrument panel 12, the display device arranged on the center right is referred to as the first display device 41, the display device arranged on the center left is referred to as the second display device 42, the display device arranged on the right end is referred to as the third display device 43, and the display device arranged on the left end is referred to as the fourth display device 44.

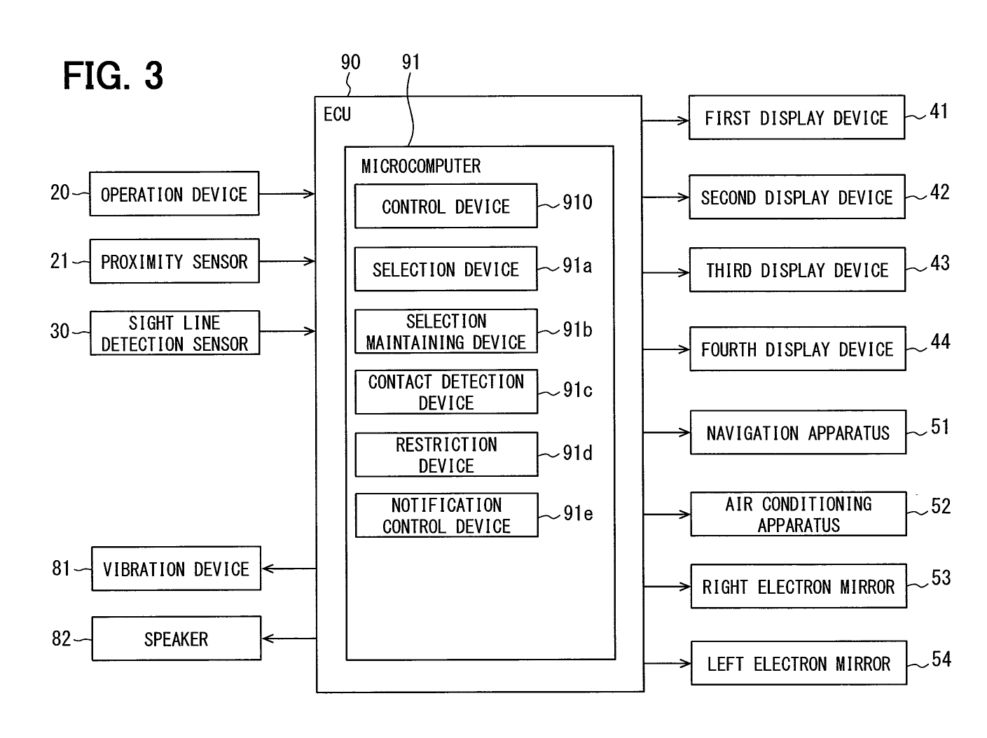

As illustrated in FIG. 2, display areas for displaying information corresponding to action contents of various apparatuses (described below, refer to FIG. 3) are set in the liquid crystal panels of the display devices 41, 42, 43, 44. The display areas are previously set as sight line areas 41a, 42a, 43a, 44a which are set in association with the apparatuses.

As illustrated in FIG. 3, the vehicle 10 is equipped with apparatuses including a navigation apparatus 51, an air conditioning apparatus 52, a right electron mirror 53, a left electron mirror 54, and an audio apparatus (not illustrated). The navigation apparatus 51 navigates travel of the vehicle 10. The air conditioning apparatus 52 controls air conditioning inside the vehicle cabin. The right electron mirror 53 is provided with a camera which captures an image of an object outside the vehicle such as another vehicle or a pedestrian, the object being located on the right side of the vehicle 10, and an actuator which controls an image capturing direction of the camera. The left electron mirror 54 is provided with a camera which captures an image of an object outside the vehicle, the object being located on the left side of the vehicle 10, and an actuator which controls an image capturing direction of the camera.

Information corresponding to action contents of the navigation apparatus 51 is displayed in the sight line area 41a of the first display device 41. For example, map information, current position information of the vehicle 10, position information of a destination, and traveling route information are displayed. Further, a highlighting display frame is displayed in a frame area 41b which is an area other than the sight line area 41a in the first display device 41. The frame area 41b is set in an annular shape surrounding the sight line area 41a.

Information corresponding to action contents of the air conditioning apparatus 52 is displayed in the sight line area 42a of the second display device 42. For example, information such as the temperature, the volume, and a blow-off port of air conditioning air is displayed. Further, a vehicle speed meter and a battery residual meter are displayed in meter areas 42b, 42c which are areas other than the sight line area 42a in the second display device 42. The meter areas 42b, 42c and the sight line area 42a are arranged in a row in the right-left direction of the vehicle. The sight line area 42a is arranged between the two meter areas 42b, 42c.

Information corresponding to action contents of the right electron mirror 53, that is, an image captured by the camera whose direction is controlled by the actuator is displayed in the sight line area 43a of the third display device 43. Further, an image (e.g., a black-painted image) different from the image captured by the camera is displayed in areas 43b, 43c other than the sight line area 43a in the third display device 43. The sight line area 41a of the first display device 41, and the sight line area 43a and the area 43b of the third display device 43 are arranged in a row in the right-left direction of the vehicle. The area 43b is arranged between the two sight line areas 41a, 43a. Accordingly, the two sight line areas 41a, 43a are arranged at a predetermined interval or more in the right-left direction of the vehicle.

Information corresponding to action contents of the left electron mirror 54, that is, an image captured by the camera whose direction is controlled by the actuator is displayed in the sight line area 44a of the fourth display device 44. Further, an image (e.g., a black-painted image) different from the image captured by the camera is displayed in areas 44b, 44c other than the sight line area 44a in the fourth display device 44. The sight line area 42a of the second display device 42, and the area 44b and the sight line area 44a of the fourth display device 44 are arranged in a row in the right-left direction of the vehicle. The area 44b is arranged between the two sight line areas 41a, 44a. Accordingly, the two sight line areas 41a, 44a area arranged at a predetermined interval or more in the right-left direction of the vehicle.

The vehicle 10 is equipped with an electronic control device (ECU 90) described below, an operation device 20, and a sight line detection sensor 30 in addition to the display devices 41, 42, 43, 44 and the various apparatuses. An operation system according to the present embodiment is provided with the operation device 20, the plurality of display devices 41 to 44, and the ECU 90. The operation device 20 is manually operated by a user to give a command for action contents to a control target apparatus selected from the plurality of apparatuses. The selection is performed by the sight line detection sensor 30 and the ECU 90.

The sight line areas 41a, 42a, 43a, 44a are set in association with the respective apparatuses. Specifically, the sight line area 41a of the first display device 41 is set in association with the navigation apparatus 51. The sight line area 42a of the second display device 42 is set in association with the air conditioning apparatus 52. The sight line area 43a of the third display device 43 is set in association with the right electron mirror 53. The sight line area 44a of the fourth display device 44 is set in association with the left electron mirror 54. When a sight line direction detected by the sight line detection sensor 30 is within any of the sight line areas, the apparatus associated with the corresponding sight line area is selected.

The operation device 20 is disposed on the extending portion 12c at a position within the reach of a driver (user) of the vehicle 10 seated on a driver's seat. In the example of FIG. 1, a steering wheel 13 for controlling a traveling direction of the vehicle 10 is disposed at the left side in the right-left direction of the vehicle, and the operation device 20 is disposed at the opposite side (the right side) of the steering wheel 13. Specifically, the operation device 20 is disposed at the center in the right-left direction of the vehicle inside the vehicle cabin. The operation device 20 is operated by a user in three directions: an x-axis direction, a y-axis direction, and a z-axis direction. The x-axis direction corresponds to the right-left direction of the vehicle, the y-axis direction corresponds to the front-rear direction of the vehicle, and the z-axis direction corresponds to an up-down direction. That is, a tilting operation in the x-axis direction and the y-axis direction and a pushing operation in the z-axis direction can be performed.

For example, a display mode illustrated in FIG. 2 shows a state in which the navigation apparatus 51 is selected as the control target apparatus. When the operation device 20 is tilted in the x-axis direction or the y-axis direction in this state, a map displayed in the sight line area 41a of the first display device 41 is scrolled in the right-left direction or the up-down direction (refer to arrows in FIG. 2). Alternatively, a selected one of a plurality of icons displayed in the sight line area 41a is switched. When the operation device 20 is pushed in the z-axis direction, the selected icon is confirmed, and designation associated with the selected icon is output to the navigation apparatus 51. The navigation apparatus 51 acts in accordance with the command, and the contents of the action are displayed in the sight line area 41a.

In short, a manual operation of the operation device 20 includes a selection operation for selecting a desired command from a plurality of commands and a confirmation operation for confirming the selected command. In the example illustrated in FIG. 2, the tilting operation corresponds to the selection operation, and the pushing operation corresponds to the confirmation operation.

A proximity sensor 21 is attached to the extending portion 12c of the instrument panel 12. The proximity sensor 21 changes an output signal in response to the approach of a detection target. A microcomputer 91 of the ECU 90 detects a state in which a user is laying his/her hand on the operation device 20 on the basis of a change in a signal output from the proximity sensor 21. The microcomputer 91 during the execution of the detection corresponds to a “contact detection device 91c”. The proximity sensor 21 may output an ON signal when a detection target has approached a position within a predetermined range. In this case, the contact detection device 91c detects a state in which a user is laying his/her hand on the operation device 20 upon acquisition of the ON signal.

The sight line detection sensor 30 includes an infrared camera which is attached to a part of the instrument panel 12 that is located in front of a driver and a microcomputer for image analysis. The infrared camera captures an image of right and left eye balls of a driver, and the microcomputer analyzes the captured image to calculate the sight line direction of the driver. The image analysis may be executed by the microcomputer (the microcomputer 91) included in the ECU 90.

The microcomputer 91 of the ECU 90 controls the actions of the apparatuses on the basis of the sight line direction of a user detected by the sight line detection sensor 30 and operation contents of the operation device 20. The microcomputer 91, when performing control in this manner, corresponds to a “control device 910”.

The microcomputer 91 selects, on the basis of a sight line direction of a user detected by the sight line detection sensor 30, an apparatus corresponding to the slight line area within the sight line direction as the control target apparatus. The microcomputer 91, when selecting the control target apparatus in this manner, corresponds to a “selection device 91a”. For example, when the sight line area within the sight line direction is the sight line area 41a of the first display device 41 as illustrated in FIG. 2, the navigation apparatus 51 corresponding to the sight line area 41a is selected as the control target apparatus by the selection device 91a.

During a period when a state in which a user is laying his/her hand on the operation device 20 is detected by the contact detection device 91c, sight line detection by the sight line detection sensor 30 is enabled, and the selection device 91a executes the above selection. Even when the sight line direction is changed to a position deviated from all the sight line areas 41a, 42a, 43a, 44a with any of the apparatus selected as the control target apparatus, the microcomputer 91 maintains the current selection. The microcomputer 91, when functioning in this manner to maintain the selection, corresponds to a “selection maintaining device 91b”. In other words, the control device 910 makes a sight line direction detected by the sight line detection sensor 30 effective so as to be reflected in control of the apparatus on the condition that contact is detected by the contact detection device 91c.

When the sight line deviates from the sight line area corresponding to the control target apparatus, the microcomputer 91 restricts a command by the operation device 20. The microcomputer 91, when performing the restriction in this manner, corresponds to a “restriction device 91c1”. For example, the restriction device 91d enables a command by the tilting operation (selection operation) of the operation device 20 and, at the same time, disables a command by the pushing operation (confirmation operation) thereof. Further, the restriction device 91d disables a command by the operation device 20 when the sight line deviates from the sight line area corresponding to the control target apparatus for a predetermined time or more. That is, both the selection operation and the confirmation operation are disabled.

A vibration device 81 (notification device) illustrated in FIG. 3 is attached to a steering or the driver's seat to apply vibrations to a user. A speaker 82 (notification device) outputs an alarm sound or a voice. For example, a user is notified of various states such as when the selection has been confirmed and when the selection has been changed using vibrations, an alarm sound, or a voice.

When a command is restricted by the restriction device 91d, the microcomputer 91 controls actuation of the vibration device 81 (notification device) or the speaker 82 (notification device) so as to notify a user of the restriction. The microcomputer 91, when performing control in this manner, provides a “notification control device 91e”. For example, when the restriction is performed by the restriction device 91d, the notification control device 91e actuates the vibration device 81 which is attached to the driver's seat or the steering or performs a voice guidance indicating the restriction using the speaker 82.

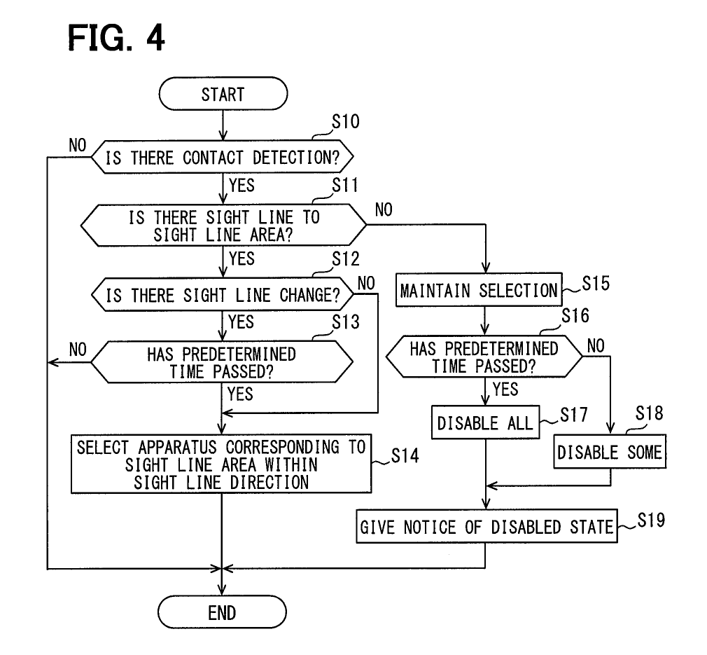

FIG. 4 is a flowchart illustrating a procedure of processing which is repeatedly executed by the microcomputer 91 at a predetermined operation period. First, in step S10, the presence or absence of contact detection by the proximity sensor 21 is determined. When the contact detection is determined to be present, it is estimated that a user is laying his/her hand on the operation device 20. Accordingly, it is considered that the user has an intention of giving a command to an apparatus using the operation device 20, and a move to the next step S11 is made. In step S11, it is determined whether the user is looking at any of the sight line areas, that is, whether any of the sight line areas is within a sight line direction detected by the sight line detection sensor 30. Specifically, it is determined whether any of the sigh line areas 41a, 42a, 43a, 44a is located within the sight line direction.

When there is a sight line to the sight line area, it is determined whether there is a change of the sight line. Specifically, when the sight line area having the current sight line differs from the sight line area corresponding to the currently selected apparatus, it is determined that there is a change of the sight line. When none of the apparatuses is currently selected, it is determined that there is no change of the sight line.

When it is determined that there is a sight line change, it is determined whether a predetermined time or more of the sight line change has passed in the following step S13. When it is determined that the predetermined time or more has passed in step S13, or when it is determined that there is no sight line change in step S12, a move to the next step S14 is made. In step S14, an apparatus corresponding to the sight line area present within the sight line direction is selected as the control target apparatus.

When it is determined that the predetermined time or more has not passed in step S13, the processing is finished without executing the selection by step S14, and a return to step S10 is made. When it is determined that the user is looking at none of the sight line areas in step S11, the selection of the currently selected apparatus is maintained in step S15. For example, when the user takes his/her eyes off the sight line area corresponding to the control target apparatus and shifts the sight line to the front of the vehicle 10 through the front windshield 11, the selection of the apparatus is maintained.

In the following step S16, it is determined whether the sight line direction has been located at a position deviated from all the sight line areas for a predetermined time or more. When it is determined that the predetermined time has passed, all operations of the operation device 20 are disabled in the following step S17. Specifically, commands by both the tilting operation (selection operation) and the pushing operation (confirmation operation) are disabled. When it is determined that the predetermined time has not passed in step S16, the operations of the operation device 20 are partially disabled in the following step S18. Specifically, the command by the tilting operation (selection operation) is enabled, and, at the same time, the command by the pushing operation (confirmation operation) is disabled.

In the following step S19, at least either the vibration device 81 or the speaker 82 is actuated so as to notify a user that the command is disabled in step S17 or step S18.

As described above, according to the present embodiment, the control device 910 and the contact detection device 91c are provided in addition to the operation device 20 which is manually operated by a user. The control device 910 controls the actions of the apparatuses on the basis of a sight line direction of a user detected by the sight line detection sensor 30 and operation contents of the operation device 20. The contact detection device 91c detects that a user is in contact with the operation device 20. The control device 910 makes the sight line direction detected by the sight line detection sensor 30 effective so as to be reflected in control of the apparatus on the condition that contact is detected by the contact detection device 91c.

Accordingly, the sight line detection is enabled merely by the touch of a user on the operation device 20, and the sight line direction can be reflected in the control. Thus, it is possible to eliminate the necessity of the operation of the trigger switch according to Patent Literature 1 described above and to improve the operability. In addition, it is possible to avoid troublesomeness caused by the reflection of the sight line direction detected by the sight line detection sensor 30 in control when a user is not in contact with the operation device 20, that is, when a user has no intention of giving a command to an apparatus.

Further, in the present embodiment, the selection device 91a is provided. The selection device 91a selects, on the basis of the plurality of sight line areas which are set in association with the respective apparatuses and a sight line direction detected by the sight line detection sensor 30, one of the apparatuses associated with the sight line area within the sight line direction as the control target apparatus. The control device 910 controls the action of the control target apparatus on the basis of the operation contents of the operation device 20. Accordingly, a simple command such as the selection of the control target apparatus is performed using the sight line detection sensor 30, and a complicated command such as the setting of action contents is performed using the operation device 20. Thus, it is possible to improve the ease of giving a command to the apparatuses while achieving giving a command for action contents of the apparatuses using the operation device 20 in common.

Further, in the present embodiment, the selection maintaining device 91b is provided. Even when the sight line direction is changed to a position deviated from all the sight line areas with the control target apparatus selected, the selection maintaining device 91b maintains the selection. This makes it possible to prevent the selection from being canceled every time the sight line is moved off the sight line area associated with the selected control target apparatus. For example, even when a user looks at the sight line area 41a of the first display device 41 to select the navigation apparatus 51, and then takes his/her eyes off the sight line area 41a and shifts the sight line to the front of the vehicle through the front windshield 11, the selection of the navigation apparatus 51 is maintained. Thus, it is possible to save time and effort required to again place the sight line on the sight line area 41a to select the navigation apparatus 51 every time the sight line is moved off. Further, it is also possible to operate the operation device 20 to give a command with the sight line off the sight line area 41a.

Further, in the present embodiment, when the sight line detection sensor 30 has detected a sight line movement to a sight line area that is different from one of a plurality of sight line areas associated with the control target apparatus and a time of the sight line movement is less than a predetermined time, the selection of the control target apparatus is maintained. Accordingly, merely a short look at another sight line area does not change the selection. Thus, it is possible to look at another sight line area without changing the selection of the control target apparatus.

Further, in the present embodiment, the restriction device 91d is provided. The restriction device 91d restricts a command by the operation device 20 when the sight line direction is changed to a position deviated from all the sight line areas 41a, 42a, 43a, 44a with the control target apparatus selected. Accordingly, when a user takes his/her eyes off the sight line areas 41a, 42a, 43a, 44a, the command by the operation device 20 is restricted with the selection maintained. Thus, for example, even when a user does not look at information corresponding to action contents displayed in the sight line areas 41a, 42a, 43a, 44a and thus performs a wrong operation, the command is restricted by the restriction device 91d. Thus, it is possible to prevent the apparatus from acting against the user's intention by the wrong operation.

Further, in the present embodiment, the restriction device 91d enables a command by the selection operation of the operation device 20 and, at the same time, disables a command by the confirmation operation. Accordingly, even when a user takes his/her eyes off the sight line areas 41a, 42a, 43a, 44a, the selection is maintained, and a command by the selection operation can be performed. Thus, for example, when information corresponding to action contents is displayed in the sight line areas 41a, 42a, 43a, 44a, it is possible to enable a blind operation without looking at the display to improve the operability. In addition, since a command by the confirmation operation is disabled, it is possible to prevent the apparatus from acting against the user's intention by a wrong operation.

Further, in the present embodiment, when the sight line direction remains at a position deviated from all the sight line areas 41a, 42a, 43a, 44a for a predetermined time or more with the control target apparatus selected, commands by the selection operation and the confirmation operation are disabled. When a user is not looking at the sight line areas 41a, 42a, 43a, 44a for a predetermined time or more, there is a high possibility that the user has no intention of operating the operation device 20 to give a command to an apparatus. Thus, the present embodiment which disables commands by the selection operation and the confirmation operation in such a case makes it possible to further reliably prevent the apparatus from acting against the user's intention by a wrong operation.

Further, in the present embodiment, the notification control device 91e is provided. When a command is restricted by the restriction device 91d, the notification control device 91e controls the actuation of the vibration device 81 or the speaker 82 so as to notify a user of the restriction. Accordingly, it is possible to reduce the possibility that a user who has noticed the command restriction misunderstands the command restriction as a failure of the operation system.

Further, in the present embodiment, the sight line areas 41a, 42a, 43a, 44a are provided for the respective apparatuses and set as display areas for displaying information corresponding to action contents. Accordingly, it is possible to give a command to change action contents by manually operating the operation device 20 while looking at information corresponding to the action contents displayed in the sight line area. For example, in the example of FIG. 2, the navigation apparatus 51 is selected as the control target apparatus, and it is possible to scroll map information displayed in the sight line area 41a by manually operating the operation device 20 while looking at the map information. Thus, it is possible to easily give a command to even an apparatus that requires a command for complicated action contents.

In addition, selection of any one of the apparatuses as the control target apparatus can be performed merely by looking at the sight line area corresponding to the desired apparatus. For example, when the sight line is shifted to the sight line area 42a of the second display device 42 in a state of FIG. 2 in which the navigation apparatus 51 is selected as the control target apparatus, the apparatus (the air conditioning apparatus 52) corresponding to the second display device 42 is selected as the control target apparatus. In short, a simple command such as the selection of the control target apparatus is performed using the sight line detection sensor 30, and a complicated command such as the setting of action contents is performed using the operation device 20.

Further, in the present embodiment, the frame area 41b (selection notification display unit) is provided. The frame area 41b gives notice of selecting the sight line area corresponding to the control target apparatus by the selection device 91a. This makes it easy for a user to recognize which one of the apparatuses is currently selected as the control target apparatus. Thus, it is possible to further improve the ease of giving a command to the apparatuses.

### Second Embodiment

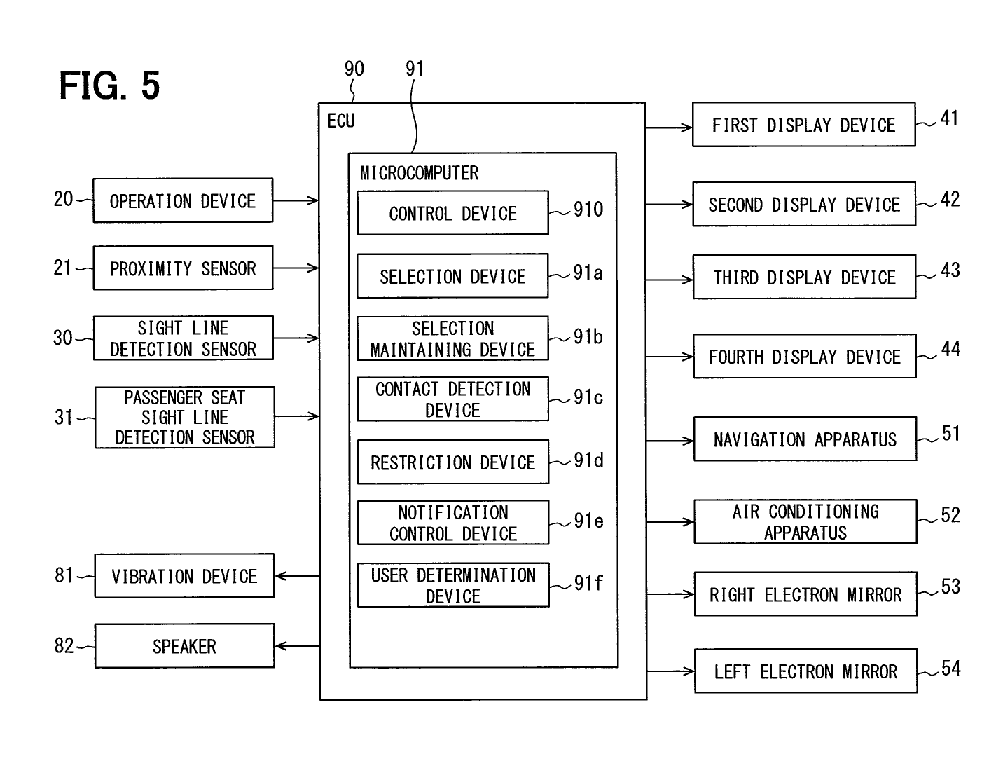

In the above first embodiment, it is assumed that an occupant on the driver's seat (driver) of the vehicle 10 operates the operation device 20, and the sight line detection sensor 30 is disposed in front of the driver's seat for detecting the sight line of the driver. On the other hand, in the present embodiment, it is assumed that both an occupant on the passenger seat (passenger seat occupant) and a driver of the vehicle 10 operate the operation device 20. Further, in addition to the sight line detection sensor 30 which is disposed in front of the driver's seat, a passenger seat sight line detection sensor 31 is disposed in front of the passenger seat (refer to FIG. 5).

The microcomputer 91 determines whether a user who operates the operation device 20 is a driver or a passenger seat occupant. For example, proximity sensors 21 are disposed on the extending portion 12c at the passenger seat side and the driver's seat side. The contact detection device 91c determines the presence or absence of contact on the basis of an output signal of each of the proximity sensors 21. When the proximity sensor 21 at the passenger seat side has detected contact and the proximity sensor 21 at the driver's seat side has detected no contact, the microcomputer 91 determines that a user of the operation device 20 is the passenger seat occupant. In the case of the opposite detection result, it is determined that the user of the operation device 20 is the driver. The microcomputer 91 during the execution of the determination corresponds to a “user determination device 91f”.

When the user of the operation device 20 is determined to be the driver, the selection device 91a selects the control target apparatus on the basis of a sight line direction detected by the sight line detection sensor 30. When the user of the operation device 20 is determined to be the passenger seat occupant, the selection device 91a selects the control target apparatus on the basis of a slight line direction detected by the passenger seat sight line detection sensor 31.

The restriction device 71d changes the contents of restriction according to a result of determination by the user determination device 91f. For example, when the user is determined to be the driver during travel of the vehicle, restriction is performed so as to prohibit character input to the navigation apparatus 51. On the other hand, when the user is determined to be the passenger seat occupant during travel of the vehicle, the character input is allowed.

As described above, in the present embodiment, the user determination device 91f which determines whether a user who is in contact with the operation device 20 is an occupant on the driver's seat or an occupant on the passenger seat of the vehicle 10 is provided. Further, the restriction device 91d which restricts the contents of control by the control device 910 during travel of the vehicle 10 is provided. The restriction device 91d changes the contents of the restriction according to a result of determination by the user determination device 91f. Thus, also the passenger seat occupant can use the operation system in which the operation device 20 and sight line detection are cooperated with each other. Further, when the operation is restricted during travel of the vehicle, restriction that is appropriate for a user can be performed.

### Third Embodiment

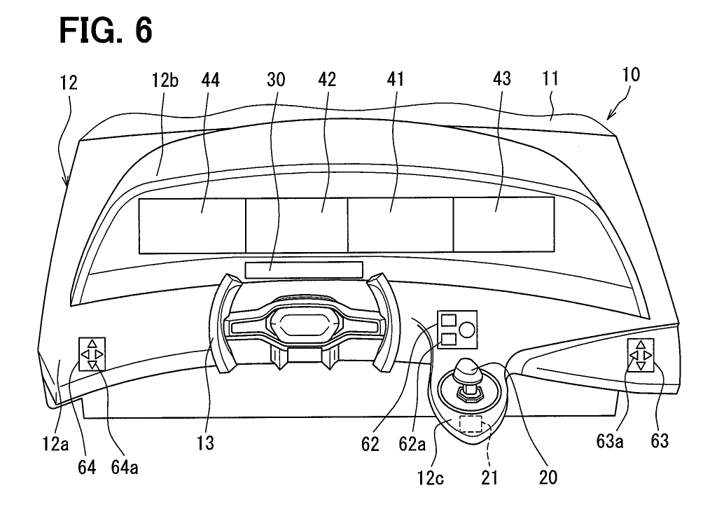

In the above first embodiment, the display areas of the display devices 41, 42, 43, 44 are respectively set as the sight line areas 41a, 42a, 43a, 44a associated with the apparatuses. On the other hand, in the present embodiment, positions of operation panels (described below) are previously set as sight line areas 62, 63, 64 (refer to FIG. 6) associated with apparatuses.

A first operation panel, a second operation panel, and a third operation panel are disposed on the instrument panel 12 at positions under the display devices 41, 42, 43, 44. The first operation panel is set as a sight line area associated with the air conditioning apparatus 52 and provided with an operation member 62a such as a switch or a dial for giving a command for action contents of the air conditioning apparatus 52. The second operation panel is set as a sight line area associated with the right electron mirror 53 and provided with an operation member 63a such as a switch for giving a command for action contents of the right electron mirror 53. The third operation panel is set as a sight line area associated with the left electron mirror 54 and provided with an operation member 64a such as a switch for giving a command for action contents of the left electron mirror 54. These operation members 62a, 63a, 64a are manually operated by a user.

The apparatuses act on the basis of the operations of the respective operation members 62a, 63a, 64a. An apparatus selected by the selection device 91a acts on the basis of the operation of the operation device 20. Also in the present embodiment, the configuration illustrated in FIG. 3 is provided similarly to the first embodiment, and the processing of FIG. 4 is executed similarly to the first embodiment. In this manner, even when the sight line areas 41a, 42a, 43a, 44a are not display areas of the display devices, the operation system according to the present disclosure can be applied.

### Other Embodiments

The preferred embodiments of the disclosure have been described above. However, the disclosure is not limited at all to the above embodiments, and can be modified and implemented in various manners as described below. In addition to a combination of configurations clearly stated in the respective embodiments, configurations of a plurality of embodiments may be partially combined even if not clearly stated unless there is an obstacle in the combination.

The proximity sensor 21 illustrated in FIGS. 1 and 2 may either a contactless sensor or a contact sensor. Further, the proximity sensor 21 may either a sensor that detects a change in a magnetic field or a sensor that detects a change in capacitance. The attachment position of the proximity sensor 21 is not limited to the extending portion 12c. For example, the proximity sensor 21 may be attached to the operation device 20.

The contact detection device 91c according to the first embodiment detects that a user is in contact with the operation device 20 on the basis of detection by the proximity sensor 21. Alternatively, the contact detection device 91c may detect that a user is in contact with the operation device 20 on the basis of that the operation device 20 is operated and outputs an operation signal. For example, the proximity sensor 21 may be eliminated, and the contact detection device 91c may detect contact when an input signal generated by operating the operation device 20 is output. Specifically, the contact detection device 91c may detect that a user is laying his/her hand on the operation device 20 on the basis of a tilting operation or a pushing operation of the operation device 20.

In the embodiment illustrated in FIG. 1, the display devices 41, 42, 43, 44 are disposed on the opening of the instrument panel 12. However, the present disclosure is not limited to such disposition. For example, the display devices may be disposed on a dashboard.

In the embodiment illustrated in FIG. 1, the plurality of display devices 41, 42, 43, 44 are arranged in a row in the right-left direction of the vehicle. However, the present disclosure is not limited to such arrangement. For example, the display devices may be arranged at positions shifted from each other in the up-down direction.

In the embodiment illustrated in FIG. 1, the operation device 20 is disposed on the instrument panel 12. However, the present disclosure is not limited to such disposition. For example, the operation device 20 is disposed on the steering wheel 13.

The devices and/or functions provided by the ECU 90 (control device) can be provided by software recorded in a substantial storage medium and a computer that executes the software, software only, hardware only, or a combination thereof. For example, when the control device is provided by a circuit as hardware, the control device can be provided by a digital circuit including many logic circuits or an analog circuit.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An operation system comprising:
an operation device manually operated by a user;
a control device that controls actions of a plurality of apparatuses according to a visual line direction of the user detected by a visual line detection sensor and an operation content of the operation device; and
a contact detection device that detects that the user touches the operation device, wherein:
the control device enables the visual line direction detected by the visual line detection sensor and reflects the visual line direction in a control of the control device when the contact detection device detects that the user touches the operation device.

2. The operation system according to claim 1, further comprising:
a selection device that selects one of the plurality of apparatuses as a control target apparatus according to a plurality of visual line regions individually set in relation to the plurality of apparatuses and the visual line direction detected by the visual line detection sensor, the one of the plurality of apparatuses relating to one of the visual line regions disposed in the visual line direction, wherein:
the control device controls an action of the control target apparatus according to the operation content of the operation device.

3. The operation system according to claim 2, further comprising:
a selection maintaining device that maintains a selection state of the control target apparatus when the visual line direction is changed to another direction pointing to none of the visual line regions while the control target apparatus is selected.

4. The operation system according to claim 2, wherein:
a selection state of the control target apparatus is maintained when the visual line detection sensor detects a visual line movement to another one of the visual line regions different from the one of the visual line regions corresponding to the control target apparatus, and a period of the visual line movement is less than a predetermined time.

5. The operation system according to claim 1 mounted on a vehicle, further comprising:
a user determination device that determines whether the user touching the operation device is an occupant on a driver's seat or an occupant on a passenger seat of the vehicle; and
a limiting device that limits a content of a control by the control device while the vehicle runs, wherein:
the limiting device changes the content of a limitation according to a result of determination by the user determination device.

6. The operation system according to claim 1, wherein:
the contact detection device detects that the user touches the operation device according to a feature that the operation device is operated and outputs an operation signal.
